(19) United States
(12) Patent Application Publication
(10) Pub. No.: US 2005/0068560 A1
(43) Pub. Date: Mar. 31, 2005

(54) Providing application specific printing with an arbitrary printing device

(76) Inventor: Andrew R. Ferlitsch, Tigard, OR (US)

Correspondence Address: Michael F. Krieger;Kirton & McConkie, 1800 Eagle Gate Tower, 60 East South Temple, Salt Lake City, UT, 84111, US

(21) Appl. No.: 10/677,011

(22) Filed: Sep. 30, 2003

(51) Int. Cl. G06F 15/00

(52) U.S. Cl. 358/1.13

(57) ABSTRACT

Systems and methods for specifying application specific printing requirements for an arbitrary printing device without the aid of a fully compatible printer driver or printer definition that specifies the implementation of the printing requirement for a specific printer. Application specific printing requirements are specified for an arbitrary printing device. A printing device is able to have multiple sets of default device settings, such as factory default settings, standard default settings, and one or more sets of application specific default settings. A user may easily configure the printer device for a specific application without having a fully compatible printer driver or without specific knowledge of the implementation of the option/settings, and without interfering with printing from other print environments that require a conventional mechanism (e.g., printer driver, standard default settings, etc.), by utilization of the front-panel of the printer device, a web page, device management protocol or a pseudo print job.

### BACKGROUND OF THE INVENTION

1. Field of the Invention

The present invention relates to application specific rendering. In particular, the present invention relates to systems and methods for specifying application specific printing requirements for an arbitrary printing device without the aid of a fully compatible printer driver or printer definition that specifies the implementation of the printing requirement for a specific printer.

2. Background and Related Art

When a user chooses to print a document or image according to a desired set of print requirements (e.g., number of copies, collation, paper selection, finishing), the user must either select options from a print requirement generation process (e.g., printer driver) that is compatible with the printing device, or have the default settings of the printing device set to the print requirements.

There are situations when the above requirements cannot be easily satisfied, resulting in either undesired results or laborious efforts to obtain the desired result. One such example is in the AS/400 operating system using the Host-Print-Transform (HPT) function to print to an ASCII (e.g., PCL) printer. In this system, report program generators (RPG) generate print data according to a printer class (e.g., PCL printer) and not specifically to a printer model. Downstream from the report generation process, the Host-Print-Transform process modifies the print data from the generalized printer class to be compatible with the specific implementation of a printer from that printer class (i.e., printer model).

To accomplish this, the HPT process uses a Work Station Customization Object (WSCO), which describes that printer's implementation of the printer's options/settings. Further, the user may associate print requirements, in addition to those generated by an RPG, with a print queue to which the print job has been spooled.

Several problems can occur in this process of modifying or adding print requirements in an implementation that is compatible with the printer. For example, (i) not all of the print option/settings that are supported by the printer have their implementation specified in the WSCO (or other printer definition method); (ii) a WSCO (or other printer definition method) does not exist for the specific printer model; (iii) the method of specifying an option/setting in the WSCO (or other printer definition method) does not support specifying all the option/settings for the specific printer model; and (iv) the spooler/de-spooling process may lack the ability to associate one or more specific additional print requirements, even though their implementations are specified in the WSCO (or other printer definition method).

Further, an operator may encounter laborious situations when an existing RPG print job is adapted to new print requirements or is printed to a replacement printer. In the former case, the operator must know how to modify the existing print settings to the application, and possibly update a WSCO (or other printer definition method). For legacy applications, the operator may not have the skill or knowledge to perform these actions.

In the later case, the operator must know how to reconfigure the print settings for the application, such as installing a replacement WSCO and possibly update the WSCO (or other printer definition method) and/or alter the print settings associated with the print queue to conform to a naming convention of the replacement printer. For legacy applications, the operator may not have the skill or knowledge to perform these actions, or the organization may not have the will to undertake such an effort.

In other environments that utilize a printer driver, when the printer driver converts printer independent printing instructions to printer dependent printing instructions the user may not have a printer driver that is fully compatible with the printing device's capabilities and options/settings.

Thus, challenges exist with the current techniques. A desire exists for a more convenient method for specifying application specific printing requirements for an arbitrary printing device. Accordingly, it would be an improvement in the art to augment or even replace current techniques with other techniques.

### SUMMARY OF THE INVENTION

The present invention relates to application specific rendering. In particular, the present invention relates to systems and methods for specifying application specific printing requirements for an arbitrary printing device without the aid of a fully compatible printer driver or printer definition that specifies the implementation of the printing requirement for a specific printer.

Implementation of the present invention takes place in association with specifying application specific printing requirements for an arbitrary printing device, without the aid of a fully compatible printer driver or printer definition that specifies the implementation of the printing requirements for a specific printer, such as in an AS/400 or other printing environment. In at least some implementations of the present invention, a printing device is capable of having multiple sets of default device settings. The printing device includes factory default settings, standard default settings, and one or more sets of application specific default settings.

When the default settings for a device are configured, such as from the front-panel, a web page, or from a print job (e.g., @PJL DEFAULT), the default settings are associated with either standard default settings (default settings of a conventional printing device) or with application specific default settings. In the later case, the printer device is able to have more than one set of default settings. When the default settings of the device are configured, the user has the option of specifying an application specific name to associate with the settings (named default). In this case, the settings are associated with the named default, and the standard default settings are left unchanged.

When the user chooses to print, the user may specify via the front panel, a web page device management protocol, or command in the print job which named default setting to use. The print job is then executed by the printer. That is, the job is initially configured based on the named default settings, which are then modified by any subsequent job specific (current) setting. In another variation, subsequent conflicting job specific settings are ignored.

Accordingly, the user may easily configure a printing device for a specific application without having a fully compatible printer driver or without specific knowledge of the implementation of the option/settings, and without interfering with printing from other print environments that require a conventional mechanism (e.g., printer driver, standard default settings, etc.).

In another implementation of the present invention, the printer automatically selects one or more named default settings based on a job characteristic, such as a job name, a user, or a document name.

While the methods and processes of the present invention have proven to be particularly useful in rendering print jobs, those skilled in the art will appreciate that the methods and processes can be used in a variety of different applications and may be used in association with fax jobs, scan jobs, document management, and the like.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 is a representative embodiment of a system configuration in association with the present invention;

FIG. 3 is a flow chart that illustrates representative processing for entering application specific default settings;

FIG. 4 illustrates a representative embodiment for entering multiple named default device settings from a front panel;

FIG. 5 illustrates a representative embodiment for entering multiple named default device settings from a print job;

FIG. 6 is a flow chart that illustrates representative processing relating to initialization of a printer device;

FIG. 7 is a block diagram that illustrates a representative embodiment for initialization of a printer device;

FIG. 8 is a representative embodiment that illustrates named default settings that are set in a front panel; and

FIG. 9 is a representative embodiment that illustrates named default settings that are specified in a print job.

### DETAILED DESCRIPTION OF THE INVENTION

The present invention relates to application specific rendering. In particular, the present invention relates to systems and methods for specifying application specific printing requirements for an arbitrary printing device without the aid of a fully compatible printer driver or printer definition that specifies the implementation of the printing requirement for a specific printer.

Embodiments of the present invention take place in association with specifying application specific printing requirements for an arbitrary printing device, without the aid of a fully compatible printer driver or printer definition that specifies the implementation of the printing requirements for a specific printer. A printing device is capable of having multiple sets of default device settings. The printing device includes factory default settings, standard default settings, and one or more sets of application specific default settings.

When the default settings for a device are configured, such as from the front-panel, a web page, or from a print job (e.g., @PJL DEFAULT), the default settings are associated with either standard default settings (default settings of a conventional printing device) or with application specific default settings. In the later case, the printer device is able to have more than one set of default settings. When the default settings of the device are configured, the user has the option of specifying an application specific name to associate with the settings (named default). In this case, the settings are associated with the named default, and the standard default settings are left unchanged.

When the user chooses to print, the user may specify via the front panel, a web page, device management protocol or command in the print job which named default setting to use. The print job is then executed by the printer. That is, the job is initially configured based on the named default settings, which are then modified by any subsequent job specific (current) setting. In another variation, subsequent conflicting job specific settings are ignored.

Accordingly, the user may easily configure a printing device for a specific application without having a fully compatible printer driver or without specific knowledge of the implementation of the option/settings, and without interfering with printing from other print environments that require a conventional mechanism (e.g., printer driver, standard default settings, etc.).

In another implementation of the present invention, the printer automatically selects one or more named default settings based on a job characteristic, such as a job name, a user, or a document name.

In the disclosure and in the claims the term “print job” shall refer to any type of job that may be rendered, including fax jobs, scan jobs, document management, and the like.

The following disclosure of the present invention is grouped into two subheadings, namely “Exemplary Operating Environment” and “Application Specific Rendering.” The utilization of the subheadings is for convenience of the reader only and is not to be construed as limiting in any sense.

### Exemplary Operating Environment

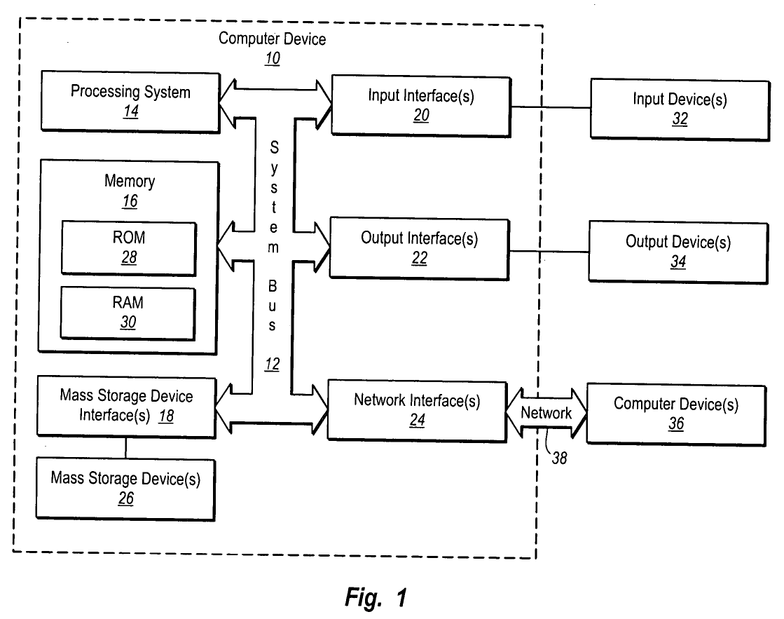

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are preformed by a plurality of networked computer devices.

Those skilled in the art will appreciate that embodiments of the present invention embrace a variety of different system configurations. For example, some embodiments of the present invention embrace local printer environments, network printer environments, remote printer environments, etc. In one embodiment, the system configuration includes one or more imaging devices (e.g., multifunctional peripherals “MFP” or other imaging devices), one or more client computer devices, optionally a server computer device, and a network communication that enables transmitting information relating to imaging jobs. Other embodiments of the present invention embrace one or more computer devices locally or remotely connected to a plurality of imaging devices for the rendering of imaging jobs.

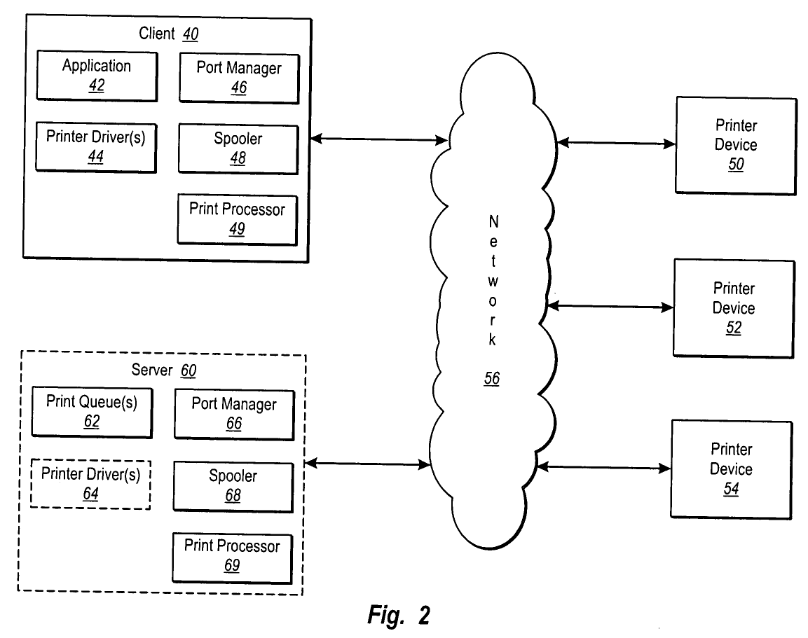

Thus, while those skilled in the art will appreciate that embodiments of the present invention may be practiced in a variety of different environments with many types of system configurations, FIG. 2 provides a representative networked configuration that may be used in association with the present invention. While FIG. 2 illustrates an embodiment that includes a client, three printer devices, and optionally a print server connected to a network, alternative embodiments include more than one client, less than three printer or other imaging devices, more than three printer or other imaging devices, no server, and/or more than one server connected to a network. Moreover, other embodiments of the present invention include local, networked, or peer-peer imaging environments, where one or more computer devices are connected to a plurality of imaging devices for rendering imaging jobs. Some embodiments include wireless networked environments, or where the network is a wide area network, such as the Internet.

The representative system of FIG. 2 includes a computer device, illustrated as client 40, which is connected to a plurality of printer devices 50-54 across network 56. In FIG. 2, printer devices 50-54 may be any type of imaging device that may be used to render a print job. In one embodiment, the capabilities of any one of the printer devices are heterogeneous to the capabilities of any other printer device (e.g., at least one of the capabilities of one printer device, such as printer device 50, are different from the capabilities of another printer device, such as printer device 52). In another embodiment, the capabilities of the printer devices are homogeneous.

As provided above, while printer devices 50-54 are connected to network 56, embodiments of the present invention embrace the use of imaging devices that are locally connected to a computer device, that are configured in a peer-to-peer imaging environment, or that are configured in a wireless network environment.

In the illustrated embodiment, client 40 includes a software application 42, one or more print drivers 44, a port manager 46, a spooler 48, and a print processor 49. A server 60 is optionally included having, for example, one or more print queues 62, one or more printer drivers 64, a port manager 66, a spooler 68, and a print processor 69.

Thus, in accordance with the illustrated embodiment and other embodiments of the present invention, application specific printing requirements are specified for an arbitrary printing device without the aid of a fully compatible printer driver or printer definition that specifies the implementation of the printing requirement for a specific printer device, as will be further discussed below.

### Application Specific Rendering

As provided above, the present invention relates to application specific rendering. In particular, the following disclosure relates to specifying one or more application specific default settings, providing printer initialization for default settings, and interpreting a print job, according to an application specific default setting.

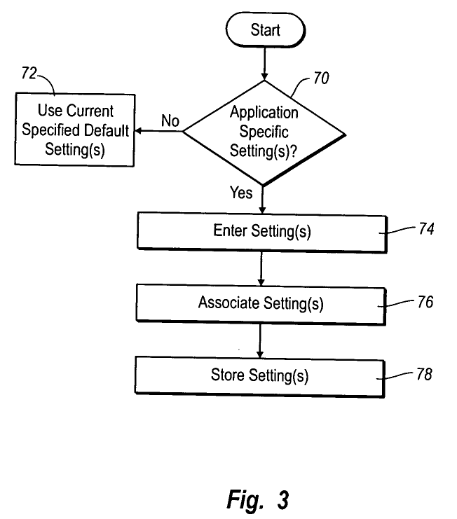

With reference now to FIG. 3, is a flow chart is provided that illustrates representative processing for entering application specific default settings. In at least some embodiments of the present invention, an imaging device (e.g., a printer, MFP, etc.) has the capability to have more than one set of non-factory default settings, such as a factory default setting, a standard default setting, and one or more application specific default settings. The standard default settings are equivalent to the default settings of a conventional device, which only allow a single non-factory default setting.

In FIG. 3, a determination is made at decision block 70 as to whether or not one or more application specific default settings are activated at an imaging device. If it is determined at decision block 70 that no application specific default setting is activated, then the imaging device defaults to the standard default setting at step 72. Thus, if no application specific name is specified, then the current specified default settings are stored as the standard default settings. In at least one embodiment, the imaging device includes means to associate the default settings with either the standard default settings or an application default settings when default settings are specified.

If it is determined at decision block 70 that an application specific default setting is activated at the imaging device, execution proceeds to step 74, where one or more settings are entered.

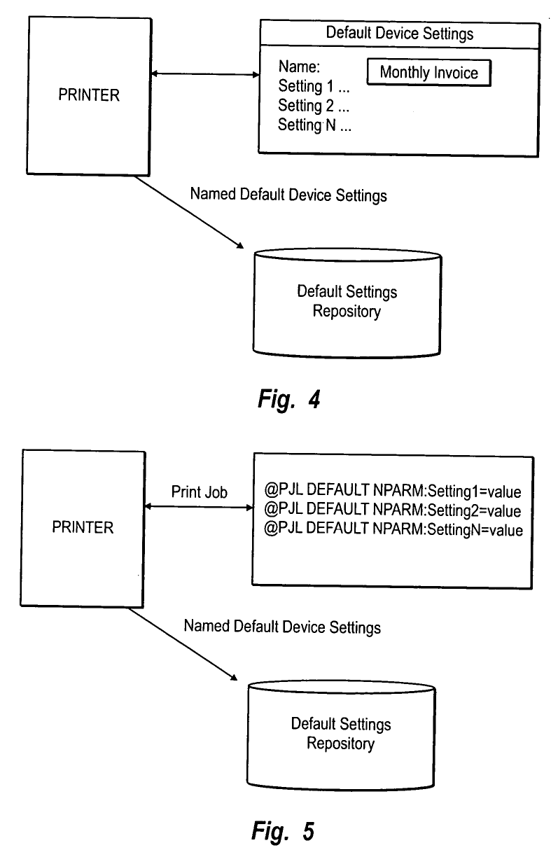

In some embodiments, default settings are entered through the front panel of the device, an embedded device web page, or a device management protocol (e.g., SNMP). In addition to entering the default settings, the user has the additional option of associating the settings with an application specific name, as illustrated by step 76. In this case, the front panel or web page includes an additional entry box to enter an application specific name to associate with the current specified default settings. When an application specific name is entered, the default settings are stored as a separate set of settings in the memory of the printer at step 78 and the application specific name is associated with the separately stored settings. The application specific name may then be used as an index/lookup to later recall and/or modify the settings. FIG. 4 illustrates a representative embodiment for entering multiple named default device settings from a front panel.

In another embodiment, as illustrated in FIG. 5, default settings are entered through a printing or non-printing print job, herein referred to as a pseudo print job. In this embodiment, the pseudo print job includes one or more commands that instruct the printer device to change and store in the memory of the printer device a default setting. In addition, the pseudo print job may also include a command that associates the current specified default settings in the pseudo print job with an application specific name. If no command is specified to associate the current specified default settings with an application specific name, then the current specified default settings are associated with the standard default settings.

For example, the specifying of default settings in a pseudo print job may be done using the print job language (i.e., PJL) DEFAULT command, as defined by Hewlett-Packard®. The following is a representative syntax:
@PJL DEFAULT<variable>=<value>

In the above example, the “@PJL DEFAULT” sequence instructs the device to change a default setting in the memory of the device. The <variable> is the name of the setting and the <value> is the new value of the setting.

In one embodiment, using the above representative command syntax to implement this invention includes introducing an optional command modifier. When present, the command modifier instructs the device to change the default setting in the memory of the device, which is associated with a specific application name. The following is an example syntax:
@PJL DEFAULT NPARM:<name><variable>=<value>

In the above example, the “NPARM:” modifier instructs the device that the changed default setting is to be associated with an application specific name, whose name is specified by <name>. This is illustrated in FIG. 5, which illustrates a representative embodiment for entering multiple named default device settings from a print job.

In another embodiment, an application specific default setting may be associated with a job characteristic instead of a name. For example, an application specific default setting may be associated with a document name, job name or user name. The following is representative syntax:
@PJL DEFAULT JPARM:<job name><variable>=<value>
@PJL DEFAULT UPARM:<user name><variable>=<value>
@PJL DEFAULT DPARM:<document name><variable>=<value>

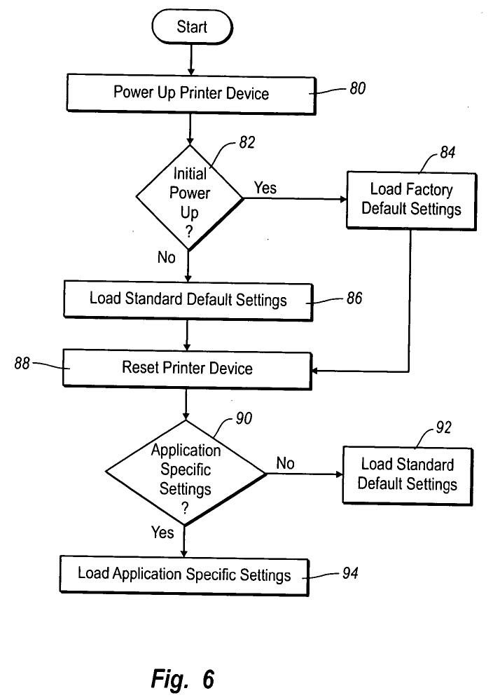

With reference now to FIG. 6, a flow chart is illustrated that provides representative processing relating to initialization of a printer device. In FIG. 6, a power up occurs at step 80. A determination is then made at decision block 82 as to whether or not the power up is an initial power up. If it is determined that it is an initial power up, the device loads the factory default settings into the standard default settings, as illustrated at step 84. Upon subsequent power ups, as illustrated by step 86, the device loads the standard default settings, which may differ from the factory default settings if they have been subsequently changed.

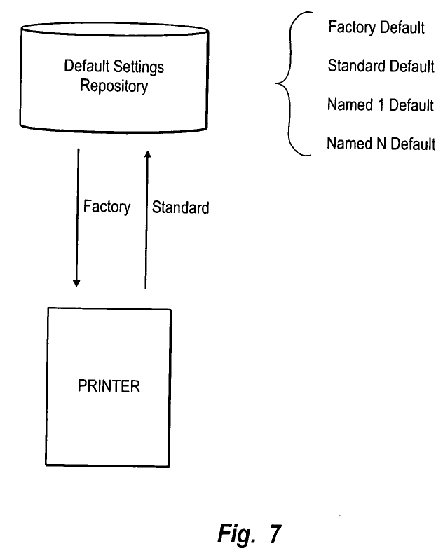

When a printer is reset after power up, as is illustrated by step 88, the printer device either loads the standard default settings or an application default settings. Thus, a determination is made at decision block 90 as to whether or not prior to the reset the printer device was loaded with specific settings. Thus, as illustrate in step 92, the standard default settings are loaded if prior to reset the printer device was loaded with the standard default settings. Alternatively, at step 94, application specific default settings are loaded if prior to the reset of the printer device, the printer device was loaded with the application specific default settings for inter-job handling (e.g., across jobs). This is further illustrated in FIG. 7, which is a block diagram that illustrates a representative embodiment for initialization of a printer device.

At run-time when a print job is interpreted by the printer, the default setting is loaded by the printer device. The default setting is loaded as the initial current job setting. Any initial job settings within the context of the job (that apply only to the job) are applied to the loaded current job setting. That is, if the default setting included parameters of A=1, B=2 and C=3 and the print job changes setting “B” to “4,” then the current job setting would be A=1, B=4 and C=3.

In accordance with at least some embodiments of the present invention, either the standard default setting or an application specific setting is loaded as the default setting. There are a number of manners for choosing which is loaded. For example, in one embodiment, there are no application specific default settings at the printer device, so the standard default setting is loaded.

In other embodiments, there are no job context triggered application specific default settings. When this is the case and there is no application specific default setting specified in the job and the inter-job default setting is set to the standard default setting, the standard default setting is loaded. Alternatively, when there are no job context triggered application specific default settings, no application specific default setting specified in the job and the inter-job default setting is set to an application specific default setting, the application specific default setting is loaded. Alternatively, when there are no job context triggered application specific default settings, but there is an application specific default setting specified in the job (i.e., intra-job), the application specific default setting is loaded.

In another embodiment, when there is a job context triggered application specific default setting, and the job context trigger exists in the job, the application specific default setting is loaded. Alternatively, when there is a job context triggered application specific default setting, and the job context trigger does not exist in the job, the rules according to item having no job context triggered application specific default settings, as discussed above, are applied.

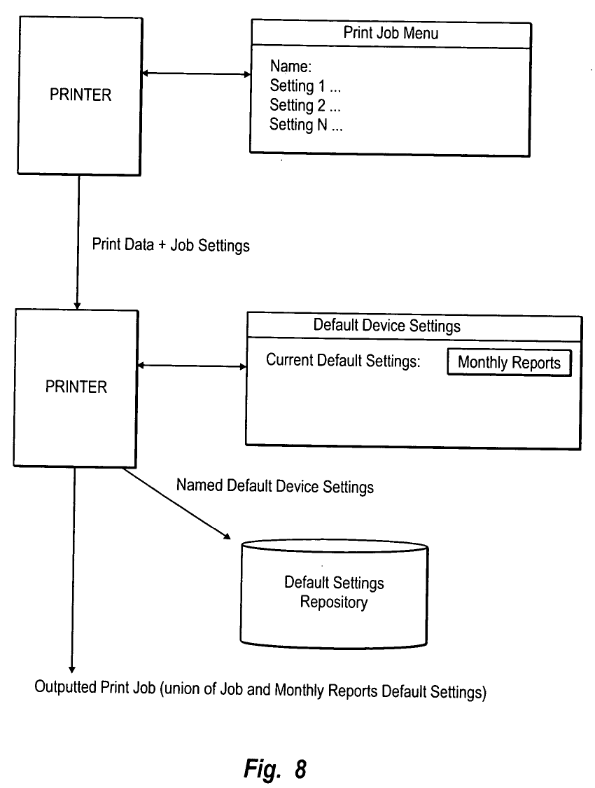

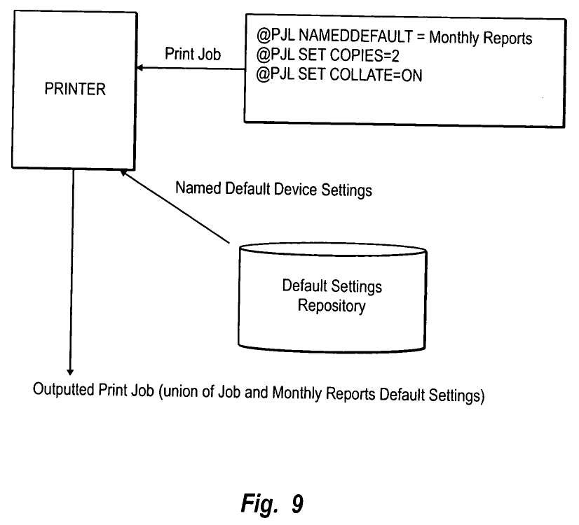

FIGS. 8 and 9 are representative embodiments, wherein FIG. 8 is a representative embodiment that illustrates named default settings that are set in a front panel, and wherein FIG. 9 is a representative embodiment that illustrates named default settings that are specified in a print job.

In another embodiment, a flag may be set with an application specific default setting to make one or more settings “sticky” throughout the context of a job. In this embodiment, the application specific default settings are first loaded as the current job settings. When a command is encountered to change a setting in the context of the job, a check is made if the setting is a “sticky” setting. If so, the command is ignored and the setting is not changed. Otherwise, the setting is changed and processing continues as normal.

In another embodiment, a client computer device adds a name to a print job. Print jobs are entered and associated with the name via a front panel of the corresponding printer device. Options are selectively obtained from a repository. The printer device applies the options associated with the name. Representative syntax includes:
@PJL DEFAULT/SET [LPARM:personality]
@PJL DEFAULT/SET [UPARM:username]
@PJL DEFAULT/SET [JPARM:jobname]0
@PJL DEFAULT/SET [NPARM:Named Default]

@PJL DEFAULT/SET SETTINGSNAME=<Named Default>

While the methods and processes of the present invention have proven to be particularly useful in rendering print jobs, those skilled in the art will appreciate that the methods and processes can be used in a variety of different applications and may be used in association with a variety of imaging operations, such as faxing, scanning, copying and document management, such as document archive/retrieval, manipulation, transfer, etc.

Thus, as discussed herein, the embodiments of the present invention embrace application specific rendering. In particular, the present invention relates to systems and methods for specifying application specific printing requirements for an arbitrary printing device without the aid of a fully compatible printer driver or printer definition that specifies the implementation of the printing requirement for a specific printer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a printing environment, a method for specifying application specific printing requirements for an arbitrary printing device, the method comprising:
providing a printing device having a plurality of default device setting sets;
configuring one of the default device setting sets by selectively associating an application specific name with one of:
(i) a standard default setting set; and
(ii) an application specific default setting;
identifying which of the default device setting sets are to be used in rendering a particular print job; and
rendering the print job without using at least one of (i) a fully compatible printer driver and (ii) a printer definition that specifies an implementation of printing requirements for the printing device.

2. A method as recited in claim 1, wherein the plurality of default device setting sets comprise:
(i) a factory default setting set;
(ii) the standard default setting set; and
(iii) the application specific default setting set.

3. A method as recited in claim 1, wherein the step for identifying which of the default device setting sets are to be used in rendering a particular print job is performed based on a characteristic of the print job.

4. A method as recited in claim 3, wherein the characteristic is one of:
(i) a job name;
(ii) a user name;
(iii) a document name;
(iv) an account code; and
(v) a department code.

5. A method as recited in claim 1, wherein the step for configuring one of the default device setting sets is initiated by at least one of:
(i) a web page;
(ii) a print job; and
(iii) input received at a-front panel of the printing device.

6. A method as recited in claim 1, wherein the step for configuring one of the default device setting sets is initiated by a device management protocol.

7. A method as recited in claim 1, further comprising performing an authentication procedure prior to utilization of the application specific default setting.

8. A method as recited in claim 1, further comprising using a flag in association with the application specific default setting to prevent the application specific default setting from being changed.

9. A method as recited in claim 1, further comprising:
associating an application specific name with the application specific default setting to create a named default setting; and
allowing the standard default setting set to be unchanged.

10. A method as recited in claim 9, further comprising:
configuring the print job based on the named default setting; and
modifying the named default setting by a job specific setting.

11. A printing device comprising:
a plurality of default device setting sets, wherein the default device setting sets are configured by selectively associating an application specific name with one of (i) a standard default setting set and (ii) an application specific default setting, wherein one of the default device setting sets is used in rendering a particular print job without using at least one of (i) a fully compatible printer driver and (ii) a printer definition that specifies an implementation of printing requirements for the printing device.

12. A printing device method as recited in claim 11, wherein the plurality of default device setting sets comprise (i) a factory default setting set, (ii) the standard default setting set, and (iii) the application specific default setting set.

13. A printing device as recited in claim 1 1, wherein the print job is one of:
(i) a fax job;
(ii) a scan job;
(iii) a copy job; and
(iv) a document management job.

14. A computer program product for implementing within a computer system a method for specifying application specific printing requirements for an arbitrary printing device, the computer program product comprising
a computer readable medium for providing computer program code means utilized to implement the method, wherein the computer program code means is comprised of executable code for implementing the steps for:
configuring one of a plurality of default device setting sets of a printing device by selectively associating an application specific name with one of:
(i) a standard default setting set; and
(ii) an application specific default setting;
identifying which of the default device setting sets are to be used in rendering a particular print job; and
rendering the print job without using at least one of (i) a fully compatible printer driver and (ii) a printer definition that specifies an implementation of printing requirements for the printing device.

15. A computer program product as recited in claim 14, wherein the plurality of default device setting sets comprise:
(i) a factory default setting set;
(ii) the standard default setting set; and
(iii) the application specific default setting set.

16. A computer program product as recited in claim 15, wherein the step for identifying which of the default device setting sets are to be used in rendering a particular print job is performed based on a characteristic of the print job.

17. A computer program product as recited in claim 16, wherein the characteristic is one of (i) a job name, (ii) a user name, (iii) a document name, (iv) an account code, and (v) a department code.

18. A computer program product as recited in claim 14, wherein the step for configuring one of the default device setting sets is initiated by at least one of:
(i) input received at a front panel of the printing device;
(ii) a web page;
(iii) a print job; and
(iv) a device management protocol.

19. A computer program product as recited in claim 14, wherein the computer program code means is further comprised of executable code for implementing steps for:
associating an application specific name with the application specific default setting to create a named default setting; and
allowing the standard default setting set to be unchanged.

20. A computer program product as recited in claim 19, wherein the computer program code means is further comprised of executable code for implementing steps for:
configuring the print job based on the named default setting; and
modifying the named default setting by a use of a job specific setting.
